(19) United States
(12) Patent Application Publication
(10) Pub. No.: US 2004/0030929 A1
(43) Pub. Date: Feb. 12, 2004

(54) Digital audio and video distribution transmission and playback

(76) Inventors: Depeng Bi, Algonquin, IL (US); Stephen Christopher Gladwin, Chicago, IL (US); Troy Steven Denkinger, Chicago, IL (US); Jeffrey Jonathan Spurgat, Madison, WI (US)

Correspondence Address: Katten Muchin Zavis Roseman, 525 West Monroe, Suite 1600, Chicago, IL, 60661-3693, US

(21) Appl. No.: 10/416,292

(22) PCT Filed: Nov. 6, 2001
(86) PCT No.: PCT/US01/44141

(51) Int. Cl. H04L 9/00

(52) U.S. Cl. 713/201; 713/153

(57) ABSTRACT

A system for secure and non-secure distribution of digital content of digital content, such as digital audio or video data, over the Internet or other computer network starting from a server to a personal computer or other computing platform and then through conversion to analog audio or video for listening or viewing on an audio or video player. An important aspect of the invention includes wireless transmission of either digital audio or video data or analog audio or video from the computing platform, through an audio or video transmission peripheral, to an audio or video receiver device and finally to an audio or video player.

### CROSS-REFERENCE TO RELATED APPLICATIONS

This application claims priority of U.S. patent application Ser. No. 60/247,311, filed on Nov. 10, 2000. This application is related to the following commonly-owned co-pending patent applications: Ser. No. 09/649,981, filed on Aug. 29, 2000; and Ser. No. 09/709,772, filed on Nov. 8, 2000, both entitled “Structure and Method for Selecting Controlling and Sending Internet-Based or Local Digital Audio to an AM/FM Radio or Audio Amplifier”; Ser. No. 09/883,173, filed on Apr. 11, 2001, entitled “Content Protection Through Audio and Video Decrypting and Decoding Device; Ser. No. ______, filed on even date, entitled “Digital Content Subscription and Distribution System (Attorney Docket No. 11748/21); and Ser. No. ______, filed on even date, entitled “Interaction Remote Control for Audio or Video Playback and Selection (Attorney Docket No. 11748/25), all hereby incorporated by reference.

### BACKGROUND OF THE INVENTION

1.Field of the Invention

The present invention relates to a system for secure and non-secure distribution of digital content, such as audio or video data, over the Internet or other computer network from a server to a personal computer or other computing platform and then through conversion to analog audio or video for listening or viewing on an audio or video player.

2. Description of the Prior Art

Encoded, encrypted or raw digital audio or video data is known to be transmitted over a network, such as the Internet, from a server to a PC or network appliance. This encoded, encrypted, or raw data is then passed to an internal or external peripheral of a PC or network appliance. This data is handled by an external peripheral or network appliance in one of two ways. For example, the data may be wirelessly retransmitted to an audio or video player, which receives the data for immediate playback or stores it for later playback. The player handles any required decoding or decrypting of the data for playback. Alternatively, the data may be converted into an analog format and sent, either by a wired or wireless connection, to an audio or video receiving device, such as a repeater, stereo, radio, or TV, to be listened to or viewed. An important part of end-to-end distribution is providing security all the way from encryption to the point the data is converted to analog.

### SUMMARY OF THE INVENTION

The present invention relates to a system for secure and non-secure distribution of digital content of digital content, such as digital audio or video data, over the Internet or other computer network starting from a server to a personal computer or other computing platform and then through conversion to analog audio or video for listening or viewing on an audio or video player. An important aspect of the invention includes wireless transmission of either digital audio or video data or analog audio or video from the computing platform, through an audio or video transmission peripheral, to an audio or video receiver device and finally to an audio or video player.

### DESCRIPTION OF THE DRAWINGS

These and other advantages of the present invention are described in the following specification and attached drawings where:

FIG. 1 is a block diagram that provides an overview of a digital audio or video data distribution, transmission, and playback system in accordance with the present invention.

FIG. 2 is a block diagram of the system architecture of a digital audio or video data distribution, transmission, and playback system using analog transmission of audio or video in accordance with the present invention.

FIG. 3 is a block diagram of the system architecture of a digital audio or video data distribution, transmission, and playback system using digital transmission of audio or video in accordance with the present invention.

FIG. 4 is a block diagram of a computing platform in accordance with the present invention.

FIG. 5 is a block diagram of the architecture of an audio or video transmission peripheral as part of a digital audio or video data distribution, transmission, and playback system in accordance with the present invention.

FIG. 6 is a block diagram of the architecture of an audio or video receiver device as part of a digital audio or video data distribution, transmission, and playback system in accordance with the present invention.

FIG. 7 is a software flow diagram for audio or video playback on the computing platform as part of a digital audio or video data distribution, transmission, and playback system in accordance with the present invention.

FIG. 8 is a software flow diagram for audio or video playback by the peripheral interface on the audio or video transmission peripheral as part of a digital audio or video data distribution, transmission, and playback system in accordance with the present invention.

FIG. 9 is a software flow diagram for audio or video playback by the audio or video processor on the audio or video transmission peripheral as part of a digital audio or video data distribution, transmission, and playback system in accordance with the present invention.

FIGS. 10-12 are schematic diagrams of the audio or video transmission peripheral as part of a digital audio or video data distribution, transmission, and playback system in accordance with the present invention.

FIG. 13 is a schematic diagram of the audio or video transmitter component of an audio or video transmission peripheral as part of a digital audio or video data distribution, transmission, and playback system in accordance with the present invention.

FIG. 14 is a schematic diagram of the audio or video receiver device as part of a digital audio or video data distribution, transmission, and playback system in accordance with the present invention.

### DETAILED DESCRIPTION

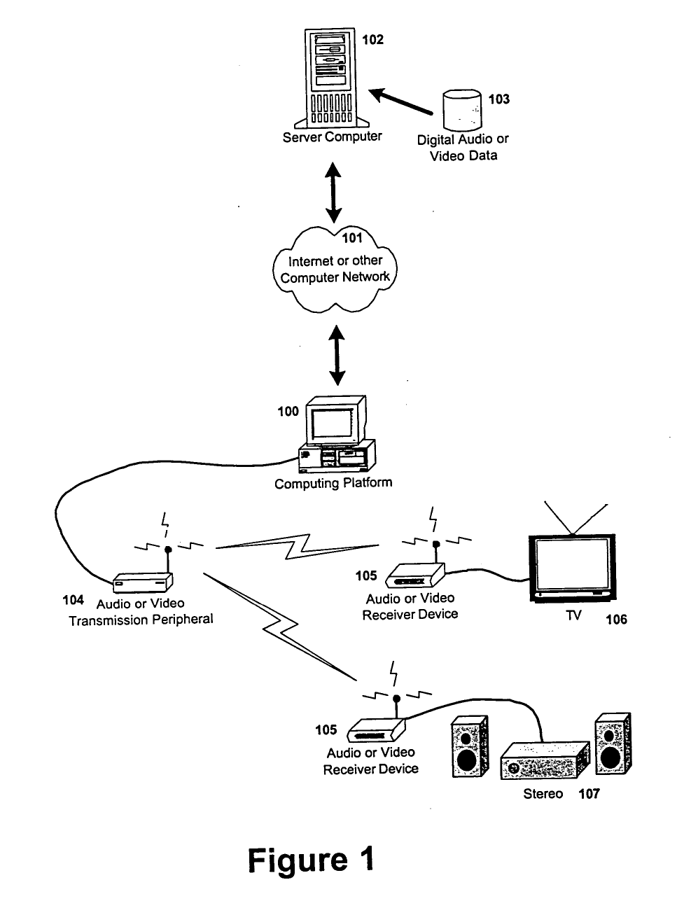

FIG. 1 provides an overview of the functionality and capabilities of a digital audio or video distribution, transmission, and playback system. Digital audio or video data 103 is sent over the Internet or other computer network 101 from a server 102 to a computing platform 100, such as a personal computer, Internet appliance or set-top box. This digital audio or video data 103, which can be encrypted or encoded for greater data security, is then passed from the computing platform 100 to an audio or video transmission peripheral 104. The audio or video transmission peripheral 104 can exist internal or external to the computing platform 100. The audio or video transmission peripheral 104 can handle the digital audio or video data 103 in one of two ways. For example, the audio or video transmission peripheral 104 may convert the digital audio or video data 103, decrypting or decoding the digital audio or video data 103, as necessary, to an analog format. The audio or video transmission peripheral 104 then wirelessly transmits this analog audio or video to the audio or video receiver device 105, which then makes the analog audio or video available for listening on a stereo 107 or viewing on a television 106. Alternatively, the audio or video transmission peripheral 104 may simply wirelessly transmits the digital audio or video data 103 in digital format to the audio or video receiver device 105. Wireless transmission can be handled by, for example, industry standard wireless networking interfaces, such as Bluetooth, HomeRF, or IEEE 802.11. The audio or video receiver device 105 then converts the digital audio or video data 103, decrypting or decoding the digital audio or video data 103 as necessary, to an analog format. The audio or video receiver device 105 then makes the analog audio or video available for listening on a stereo 107 or viewing on a television 106.

An important capability of both embodiments is providing security and protection for distribution of the digital audio and video data 103 starting from the server 102 all the way through the conversion to an analog format for listening and viewing. With either embodiment, any decrypting or decoding of the digital audio or video data 103 is handled either inside the audio or video transmission peripheral 104 or inside the audio or video receiver device 105, where the decrypted or decoded audio or video data is safe from being copied and redistributed. In both embodiments, the decrypted or decoded audio or video data is immediately converted to an analog format, thus ensuring the security and protection of the digital data. The decrypted or decoded audio or video data is not saved or stored on either the audio or video transmission peripheral 104 or the audio or video receiver device 105, eliminating the possibility of access to locally stored decrypted or decoded audio or video data.

Analog Transmission Architecture

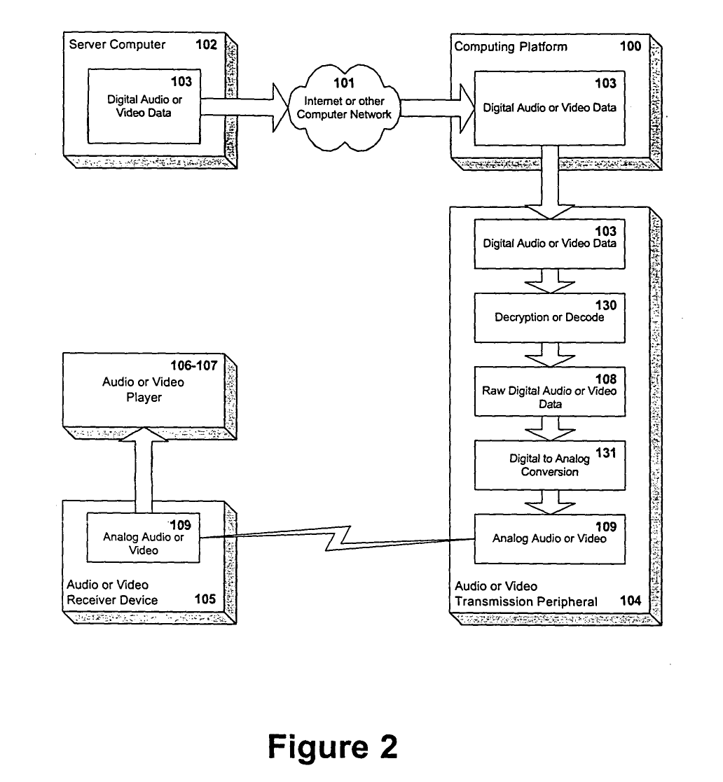

An exemplary embodiment of the system architecture for a digital audio or video distribution, transmission, and playback system using analog transmission is shown in FIG. 2. A server 102 provides digital audio or video data 103 through the Internet or other computer network 101 to a computing platform 100. The digital audio or video data 103 is then by the computing platform 100 to the audio or video transmission peripheral 104. On the audio or video transmission peripheral 104, the digital audio or video data 103 goes through decryption and/or decode 130, as necessary, to convert the digital audio or video data 103 into a raw digital audio or video data 108 format. At this point, the raw digital audio or video data 108 is protected and secure since the raw digital audio or video data 108 is inaccessible outside the audio or video transmission peripheral 104. In the audio or video transmission peripheral 104, the raw audio or video data 108 goes through a digital to analog conversion 131, where the raw audio or video data 108 is converted to analog audio or video 109. The analog audio or video 109 is then wirelessly transmitted by the audio or video transmission peripheral 104 to the audio or video receiver device 105. The analog audio or video 109 is then made available by the audio or video receiver device 105 for listening or viewing on audio or video players 106-107, such as a stereo 107 or television 106.

Digital Transmission Architecture

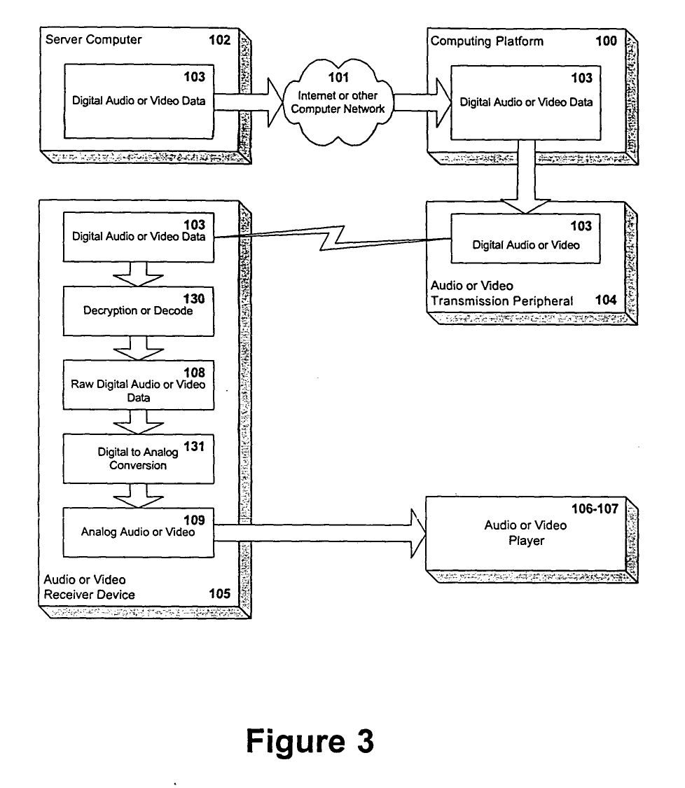

An alternative embodiment of the system architecture for digital audio or video distribution, transmission, and playback system, where digital transmission is used, is shown in FIG. 3. A server 102 provides digital audio or video data 103 through the Internet or other computer network 101 to a computing platform 100. The digital audio or video data 103 is passed by the computing platform 100 to the audio or video transmission peripheral 104. The audio or video transmission peripheral 104 wirelessly transmits the digital audio or video data 103 to the audio or video receiver device 105. Within the audio or video receiver device 105, the digital audio or video data 103 goes through decryption and/or decode 130, as necessary, to convert the digital audio or video data 103 into a raw digital audio or video data 108 format. At this point, the raw digital audio or video data 108 is protected and secure since the raw digital audio or video data 108 is inaccessible from outside the audio or video receiver device 105. In the audio or video receiver device 105, the raw audio or video data 108 goes through a digital to analog conversion 131, where the raw audio or video data 108 is converted to analog audio or video 109. The analog audio or video 109 is then made available by the audio or video receiver device 105 for listening or viewing on audio or video players 106-107, such as a stereo 107 or television 106.

Computing Platform

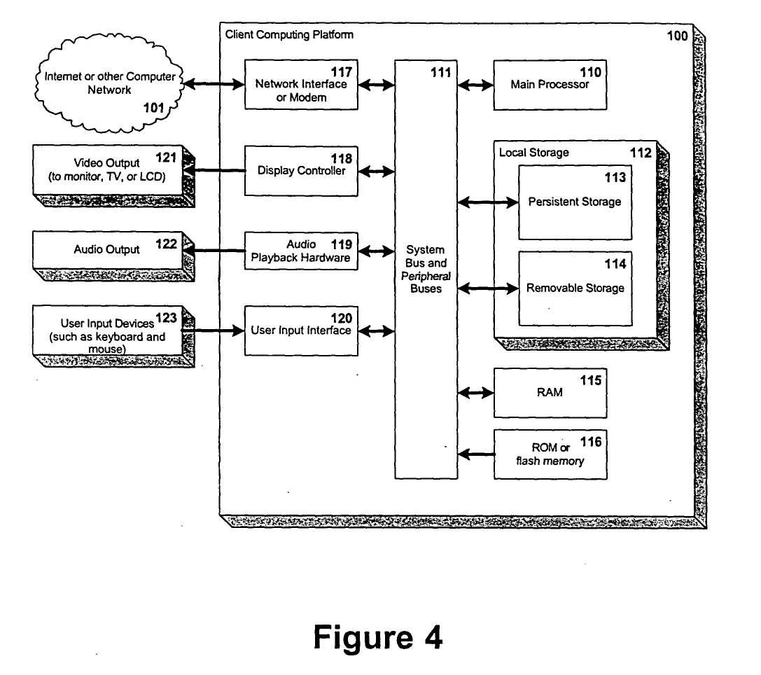

FIG. 4 illustrates an exemplary system architecture for the computing platform 100, which can encompass anything from general-purpose devices, such as a personal computer, to open fixed function devices, such as a set-top box that connects to a television set. However, a computing platform 100 is not restricted to these examples. In general, the computing platform 100 has a main processor 110, for example, an Intel Pentium III or better, for executing various software components. The various software components are typically stored in read only memory (ROM) flash memory 116 or a local storage device 112. The local storage device 112 can consist of persistent storage 113, such as hard drives or flash memory, or removable storage 114 such as floppy drives, CD-ROM drives, or DVD drives. The software components are executed by the main processor 110 directly from their storage location or are loaded into random access memory or RAM 115, to be executed from RAM 115 by the main processor 110. The computing platform 100 uses a network interface or modem 117 to access server computers 102 on the Internet or other computer network 101, in order to receive or download digital audio or video data 103. The network interface or modem 117 is connected internally or externally to the computing platform 100 using a system bus or peripheral bus 111. The system bus and peripheral buses 111 are provided for connecting internal and external devices to the computing platform 100 in a standard manner. Typical system and peripheral buses 111 include Universal Serial Bus, commonly referred to as USB, IEEE 1394 bus, commonly referred to as FireWire, and Peripheral Connect Interface, commonly referred to as PCI. The computing platform 100 may also be configured to support connection through a user input interface 120 to external or integrated user input devices 123, such as a keyboard and mouse. For output to the user, the computing platform 100 may contain a display controller 118, for example, an NVIDIA model GeForce2, which stores graphical data such as windows, bitmaps and text. The display controller 118 outputs the graphical data as video output 121 that is typically displayed to the user on a video monitor, television, or LCD panel. In addition to video output 121, the computing platform 100 can provide audio output 122, which is handled by audio playback hardware 119. However, this video output 121 and audio output 122 are not used directly as part of the audio or video distribution and playback system. It should be noted that a client computing platform 100 is not limited to the capabilities and features listed in this description, but may contain a subset of the described features or may contain additional capabilities or features not listed.

Audio or Video Transmission Peripheral

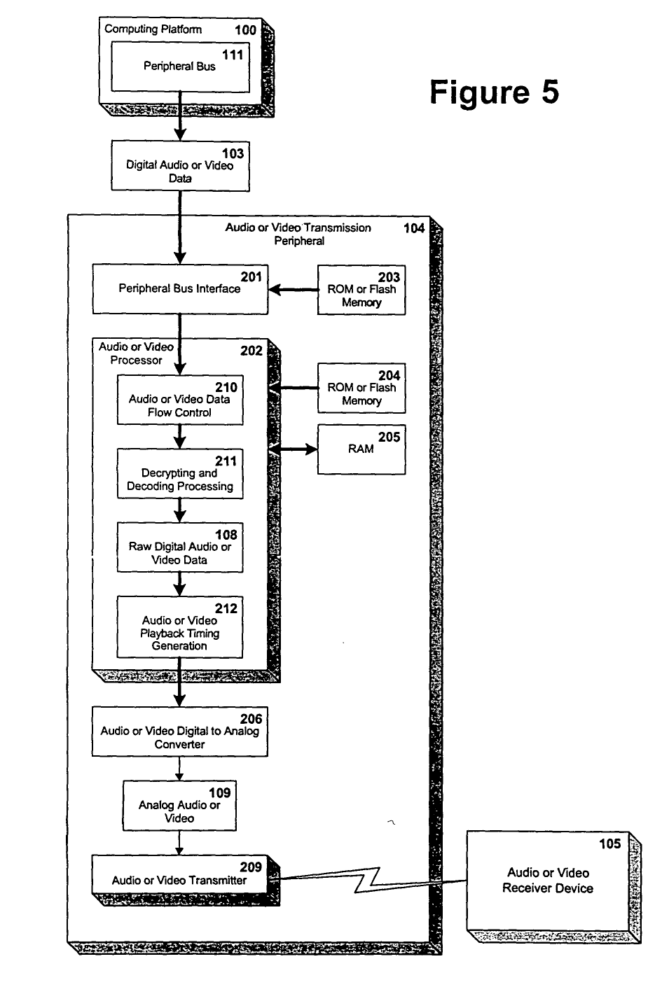

In the exemplary embodiment of an audio or video transmission peripheral 104 shown in FIG. 5, the audio or video is transmitted in analog format by the audio or video transmission peripheral 104, as described previously (FIG. 2). The audio or video transmission peripheral 104 connects to the computing platform 100 through a peripheral bus 111 on the computing platform 100, such as Universal Serial Bus, commonly referred to as USB, IEEE 1394, commonly referred to as FireWire, and Peripheral Connect Interface, commonly referred to as PCI. Digital audio or video data 103 is passed to the audio or video transmission peripheral 104 by the computing platform 100, whether or not the data is also being passed to the computing platform 100 from a server computer 102 or was already stored on the computing platform 100. The peripheral bus interface 201 on the audio or video transmission peripheral 104 receives the digital audio or video data 103 from the computing platform 100 and passes the digital audio or video data 103 to an audio or video processor 202. The audio or video processor 202 handles audio or video data flow control 210 to ensure that there is no overflow or underflow of the digital audio or video data 103. Next, the audio or video processor 202 does decrypting and decoding processing 211 on the digital audio or video data 103, as necessary, to generate raw audio or video data 108. At this point, the raw audio or video data 108 is in an unprotected format, though it is still secure since it is inaccessible external to the audio or video transmission peripheral 104. Next, the audio or video processor 202 handles audio or video playback timing generation 212 so that the raw audio or video data 108 is properly synchronized for playback. The audio or video processor 202 then passes the raw audio or video data 108 to an audio or video digital to analog converter 206, where the raw digital audio or video data 108 is converted to analog audio or video 109. The analog audio or video 109 is then passed to the audio or video transmitter 209 where the analog audio or video 109 is transmitted to the audio or video receiver device 105. The firmware run by the peripheral bus interface 201 on the audio or video transmission peripheral 104 typically comes from a read only memory, or ROM, or flash memory 203. As well, the firmware run by the audio or video processor 202 typically comes from ROM or flash memory 204. External random access memory 205, or RAM, may be used by the audio or video processor 202 for audio or video data processing and buffering, among other things. It should be noted that the functional blocks within the audio or video transmission peripheral 104 do not necessarily correspond directly to respective physical components, in the sense that multiple functional blocks may exist within a single physical component or a single functional block may represent multiple physical components.

Audio or Video Receiver Device

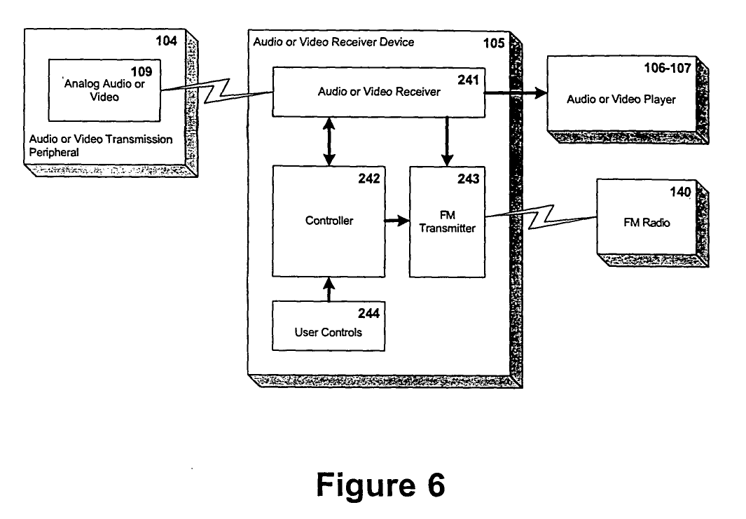

In the exemplary embodiment of an audio or video receiver device 105 shown in FIG. 6, the audio or video data is received in analog format by the audio or video receiver device 105, as described previously (FIG. 2). The audio or video transmission peripheral 104 wirelessly transmits analog audio or video data 109 for reception by the audio or video receiver 241 in the audio or video receiver device 105. The audio or video receiver 241 provides audio or video output for connection to an audio or video player 106-107, for example, a television 106 or a stereo 107. In this particular embodiment, the audio output also goes to an FM transmitter 243 in the audio or video receiver device 105, which rebroadcasts the audio output onto an unused FM radio channel for reception on a nearby FM radio 140. Radio channel selection for both the audio receiver 241 and the FM transmitter 243 is handled by a controller 242, which receives user inputs from the user controls 244, such as buttons. The user controls 244 indicate to the controller 242 the desired user selection of a specific FM radio channel for the FM transmitter 243 to broadcast on. The user controls also indicate the desire by the user for the audio receiver 241 to scan for transmission from the audio or video transmission peripheral 104 on all defined transmission frequencies. It should be noted that the functional blocks within the audio or video receiver device 105 do not necessarily correspond directly to respective physical components, in the sense that multiple functional blocks may exist within a single physical component or a single functional block may represent multiple physical components.

Audio or Video Distribution, Transmission and Playback

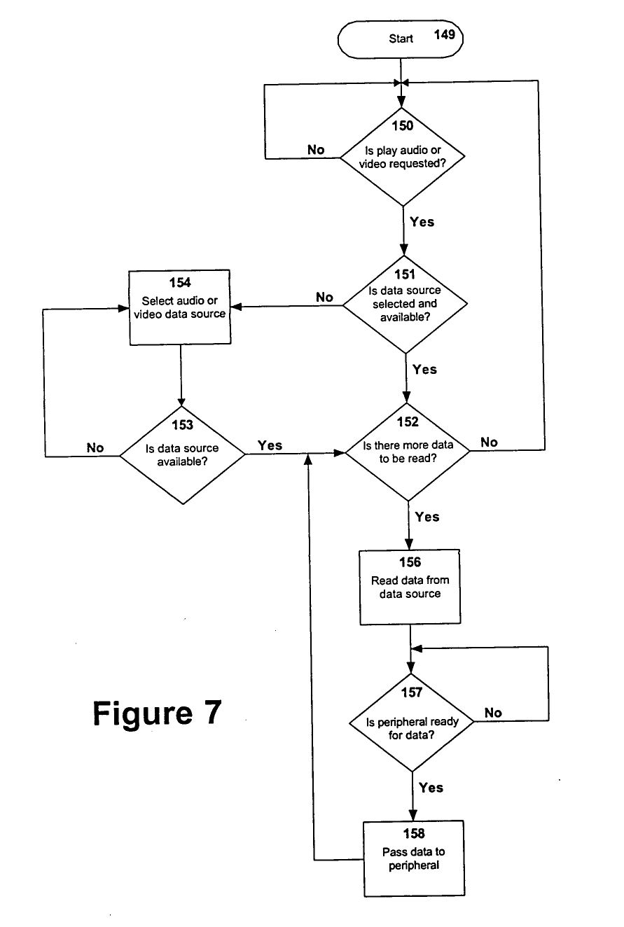

FIGS. 7-9 are software flow diagrams for audio or video distribution, transmission, and playback. These diagrams represent software flow within the computing platform 100 and the audio or video transmission peripheral 104 for distributing the digital audio or video data 103 and preparing the digital audio or video data 103 for transmission to the audio or video receiver device 105. In this exemplary embodiment, the software flow diagrams represent the system configuration where the audio or video is transmitted in analog format by the audio or video transmission peripheral 104, as described previously (FIG. 2). It should be noted that these software flow diagrams represent only one of a plethora of possible embodiments for a digital audio or video distribution, transmission and playback system.

FIG. 7 provides the software flow diagram for audio or video distribution on the computing platform 100, which in the example described henceforth, is called the distribution handler. In this embodiment, the distribution handler is a continuously running process on the computing platform 100. “Start” in step 149 represents the beginning of the distribution handler. Next, the distribution handler checks if there is a play audio or video request in step 150. The play audio or video request can be initiated either automatically by some other process or through user interaction. If a play audio or video request is found in step 150, then the distribution handler determines if there is a data source selected and available in step 151. If the data source is not selected or is not available in step 151, then selection of the audio or video data source is done in step 154. The selection of the audio or video source may be controlled by the process that made the play audio or video request in step 150 or by the user on the computing platform 100. The digital audio or video data 103 can reside locally on the computing platform 100 or on a server computer 102 accessed by the computing platform 100 over the Internet or other computer network 101. Once the selection of the audio or video source is completed in step 154, then the distribution handler verifies that the data source is available in step 153. If the data source is not available in step 153, then the selection of the audio or video data source is done again in step 154. If the data source is available in step 153 or if the data source was originally selected and available in step 151 when the play audio or video was initiated in step 150, then the distribution handler checks to see if there is more data to be read from the data source in step 152. If there is no more data to be read from the data source in step 152, then the distribution handler is done with the particular play audio or video request and the distribution handler checks for additional play audio or video requests in step 150 again. If there is more data to be read in step 152, then the distribution handler reads data from the data source in step 156. The distribution handler then checks if the audio or video transmission peripheral 104 is ready for data in step 157. This check is repeated until the audio or video transmission peripheral 104 is ready for data in step 157. Once the audio or video transmission peripheral 104 is ready for data in step 157, then the distribution handler passes the digital audio or video data 103 in step 158 to the audio or video transmission peripheral 104. When passing of the data in step 158 is complete, the distribution handler then checks again if there is more data to be read in step 152. This repeats until there is no more data to be read in step 152 from the data source. Then the distribution handler checks for another play audio or video request in step 150 again.

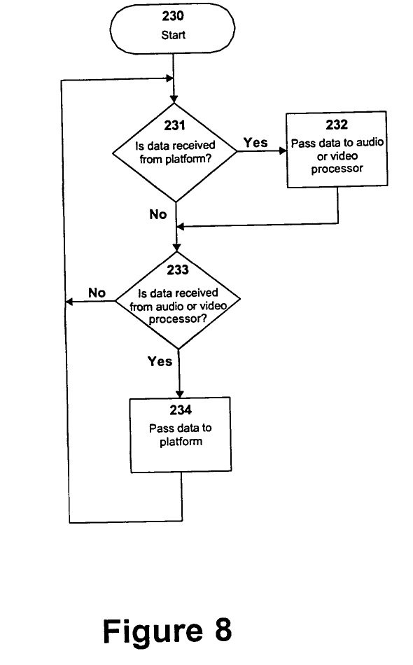

Communication by the audio or video transmission peripheral 104 with the computing platform 100 is handled by the peripheral bus interface 201 on the audio or video transmission peripheral 104. Though some functionality of the peripheral bus interface 201 may be embedded in hardware, the data flow and control is likely to be handled in firmware running on the peripheral bus interface 201. FIG. 8 shows the software or firmware flow diagram for the peripheral bus interface 201, which in the example described henceforth, is called the interface handler. In this embodiment, the interface handler is a continuously running process on the peripheral bus interface 201 as part of the audio or video transmission peripheral 104. “Start” in step 230 represents the beginning of the interface handler, which can occur when the audio or video transmission peripheral 104 is powered on or reset or when the peripheral bus interface 201 is reset. Next, the interface handler checks if there is data received in step 231 from the computing platform 100. If there is data received in step 231 from the computing platform 100, then the interface handler passes the data in step 232 to the audio or video processor 202. After the data is passed in step 232 to the audio or video processor 202 or there is no data received in step 231 from the computing platform 100, then the interface handler checks if there is data received in step 233 from the audio or video processor 202. If there is data received in step 233 from the audio or video processor 202, then the interface handler passes the data in step 234 from the audio or video processor 202 to the computing platform 100. Once the data is passed in step 234 to the computing platform 100 or there is no data received in step 233 from the audio or video processor 202, then the interface handler checks if there is data received from the computing platform 100 in step 231 again.

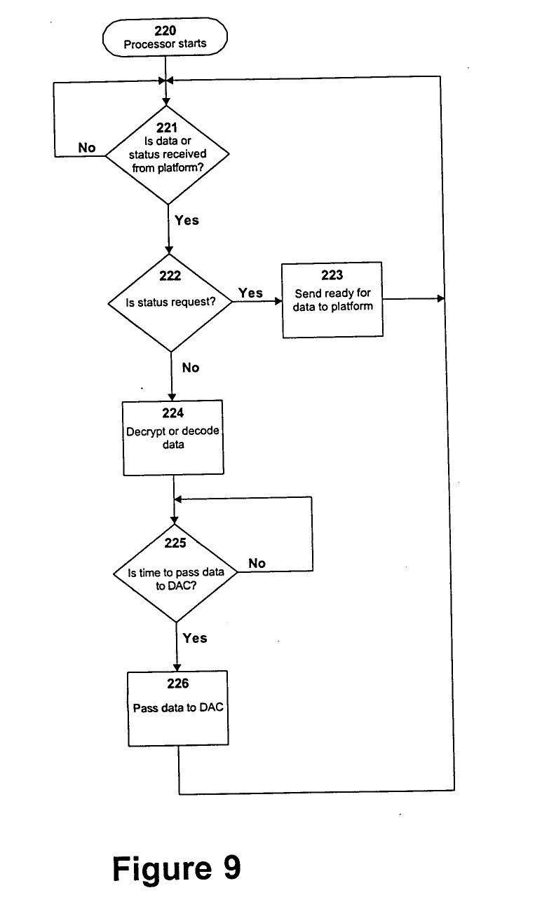

Within the audio or video transmission peripheral 104, the audio or video processor 202 provides the audio or video data flow control 210 with the computing platform 100, as well as decrypting and decoding processing 211 and audio or video playback timing generation 212, all of which has been described previously (FIG. 5). FIG. 9 provides the software or firmware flow diagram for the audio or video processor 202, which in the example described henceforth, is called the processing handler. In this example, the processing handler is a continuously running process on the audio or video processor 202 as part of the audio or video transmission peripheral 104. “Start” in step 220 represents the beginning of the processing handler, which can occur when the audio or video transmission peripheral 104 is powered on or reset or when the audio or video processor 202 is reset. Next, the processing handler checks if there is data or status request received in step 221 from the computing platform 100. It is understood, as discussed previously (FIG. 5), that communication between the audio or video processor 202 and the computing platform 100 goes through the peripheral bus interface 201. If there is data or status request received in step 221 from the computing platform 100, then the processing handler checks if there is a status request in step 222. If there is a status request in step 222, then the processing handler sends the status information in step 223, which is likely to indicate that the audio or video processor 202 is ready for more data, to the computing platform 100. Once the status information is sent in step 223 to the computing platform 100, the processing handler checks if there is data or status request received from the computing platform 100 in step 221 again. If there is not a status request in step 222 from the computing platform 100, then it is assumed that audio or video data 103 is received from the computing platform 100. The audio or video data 103 from the computing platform 100 is decrypted or decoded in step 224, as necessary. Then the processing handler, possibly in conjunction with hardware on the audio or video processor 202 or the audio or video digital to analog converter 206 or DAC, checks if it is time to pass the raw audio or video data 108 to the DAC 206 in step 225. When it is time to pass the raw audio or video data 108 to the DAC 206 in step 225, then the processing handler passes the raw audio or video data 108 to the DAC 206 in step 226. The processing handler then checks if there is data or status request received from the computing platform 100 in step 221 again.

Audio or Video Transmission Peripheral Schematic

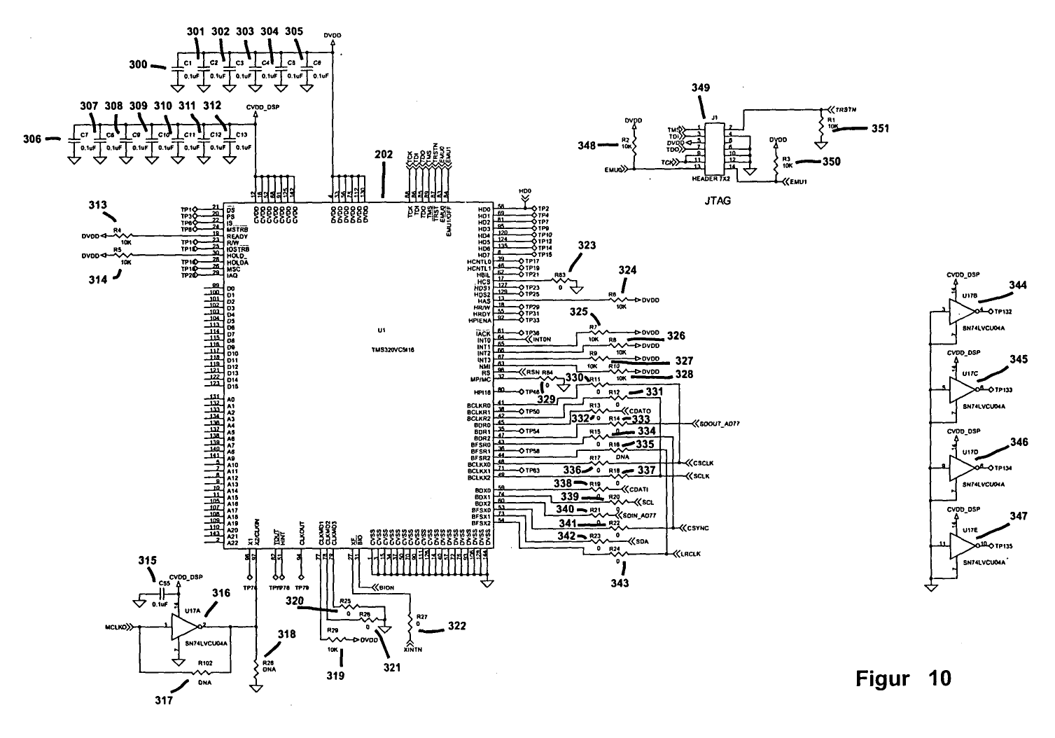

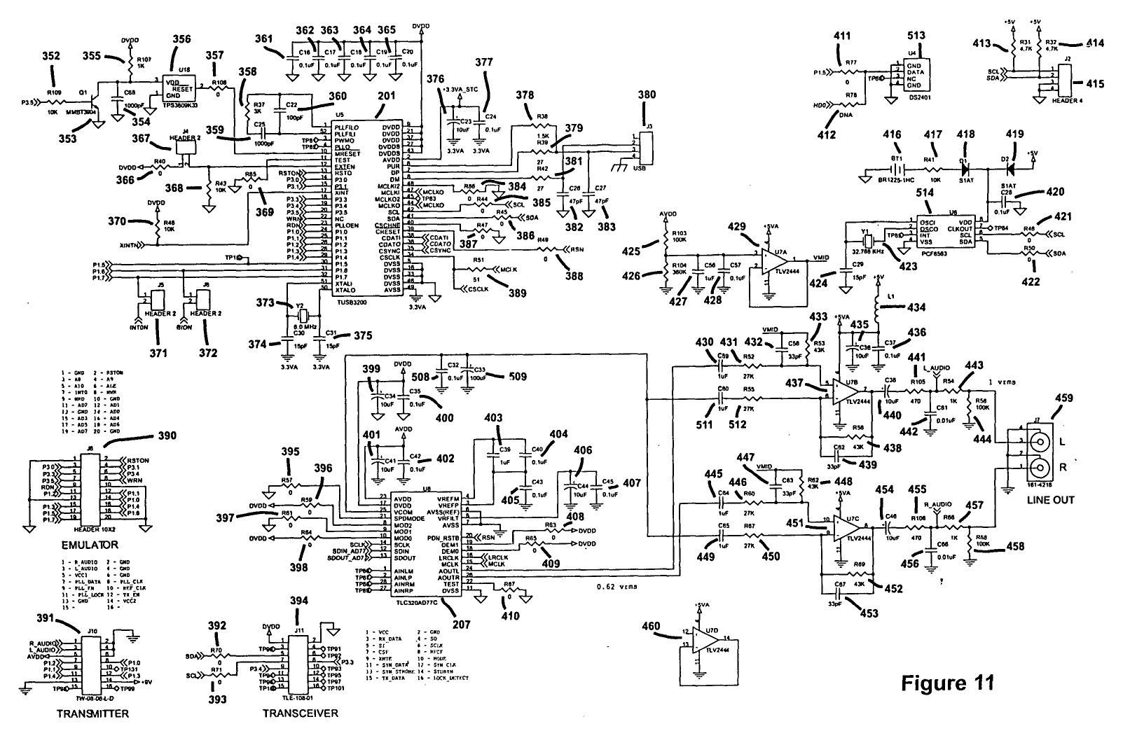

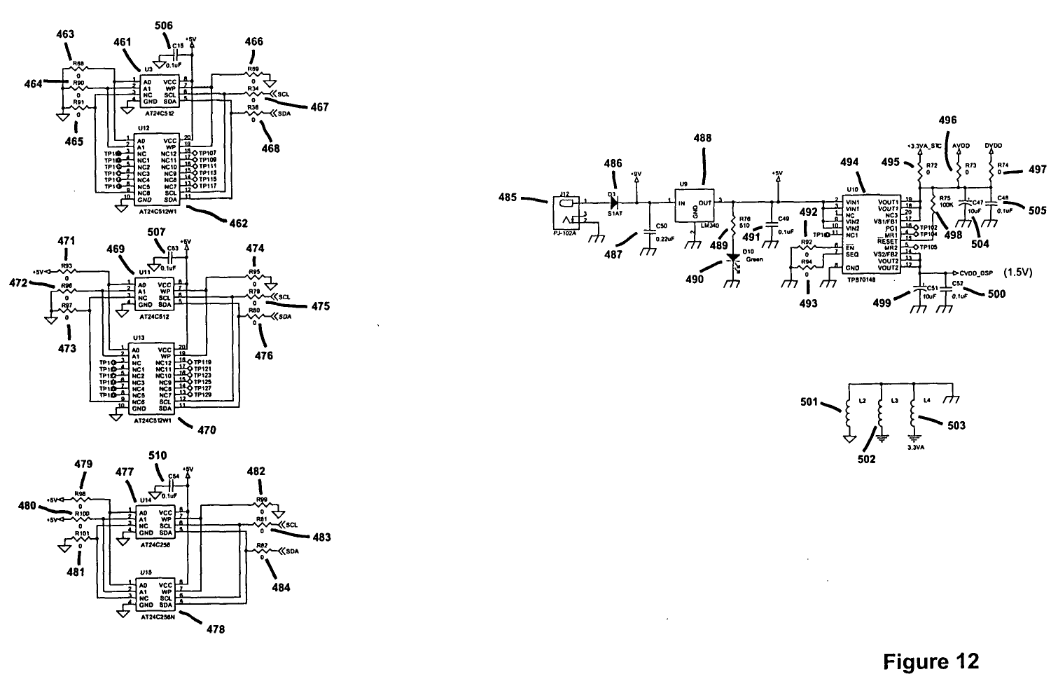

FIGS. 10 through 12 represent the schematic design for an exemplary embodiment of the audio or video transmission peripheral 104, also called the base station 104 in this description. In this particular embodiment, the audio or video transmission peripheral 104 only transmits an analog audio signal and connects to the computing platform using the peripheral interface Universal Serial Bus, commonly referred to as USB.

A USB cable connects the computing platform 100 to the base station 104 using a USB connector 380 on the base station 104. Signals from the USB connector 380 then go to the peripheral bus interface 201, which is also referred to as the USB interface controller 201. The USB interface controller 201 may be, for example, a Texas Instruments TUSB3200. A plurality of resistors 378, 379, and 381 and a pair of capacitors 382 and 383 provide the proper loading and electrostatic protection on the USB signals from the USB connector 380. A plurality of capacitors 361, 362, 363, 364, 365, 376, and 377 provide filtering for the power to the USB interface controller 201. A supply voltage supervisor 356, for example the Texas Instruments TPS3809, provides software controlled reset of the USB interface controller 201, a feature useful after completing an update of the read only memory 203, or ROM, used to store firmware for the USB interface controller 201. A pair of resistors 352 and 355, a capacitor 354, and a transistor 353 complete implementation of the software controlled reset. A resistor 357 is used to provide easier access to the reset signal from the supply voltage supervisor 356 for debug.

An oscillator 373 provides the clock for the USB interface controller 201 while a pair of capacitors 374 and 375 provide loading required by the oscillator 373. A resistor 358 and a pair of capacitors 359 and 360 provide filtering for a phase locked loop (PLL) inside the USB interface controller 201 that is used to generate additional clock signals. A resistor 389 reduces noise on the master clock signal MCLK from the USB interface controller 201 to the digital to analog converter 206, or DAC. A plurality of resistors 366, 368, 369, 370, 384, and 387 provide pull-ups to power or pull-downs to ground for various signals on the USB interface controller 201. Another group of resistors 385, 386, and 388 provide easier access to various signals on the USB interface controller 201 for debug and the headers 367, 371, and 372 provide easy connection and disconnection of signals on the USB interface controller 201 for debug.

The USB interface controller 201 reads the code it executes from ROM 203 used to store USB interface controller firmware. One 256 kilobit serial ROM may be used. This particular embodiment supports two different packaging sizes for the serial ROMs, so either serial ROM 477 or 478 is included. A plurality of resistors 479, 480, 481, and 482 act as pull-ups to power or pull-downs to ground for various signals to the serial ROMs 477 and 478. A pair of resistors 483 and 484 are for debug purposes and provide easier debug access to the I²C bus signals used by the USB interface controller 201 to communicate with the serial ROMs 477 and 478. A bypass capacitor 510 provides filtering for power to the serial ROMs 477 and 478.

The audio processor 202 is, for example, a Texas Instruments digital signal processor, or DSP, TMS320VC5416. The bypass capacitors 300, 301, 302, 303, 304, 305, 306, 307, 308, 309, 310, 311, and 312 provide filtering on the interface and core power supplied to the audio processor 202 from the dual output voltage regulator 494. Another group of resistors 313, 314, 319, 320, 321, 322, 323, 324, 325, 326, 327, 328, and 329 are used as pull-ups to power or pull-downs to ground for various signals on the audio processor 202. A plurality of resistors 330, 331, 332, 333, 334, 335, 336, 337, 338, 339, 340, 341, 342, and 343 have no impedance and simply provide better debug access to the various signals going to and coming from the audio processor 202. The resistors 330, 331, 334, 335, 336, 337, 341, and 343 also allow for the selection of access to signals from one port or another on the audio processor 202, providing additional flexibility during debug of the design. An inverter 316 provides voltage level shifting of the clock signal to the audio processor 202, while the resistor 317 allows the voltage level shifting to be bypassed if it is not needed. An inverter 316 and a resistor 317, therefore, are mutually exclusive with only one or the other being placed on the circuit board. A capacitor 315 provides bypass capacitance on the power for the inverter 316. The audio processor 202 reads the code it executes from the ROM 204 used to store DSP firmware. Two 512 kilobit serial ROMs may be used. This particular embodiment supports two different packaging sizes for the serial ROMs, so either serial ROMs 461 and 469 are included or 462 and 470 are included. A group of resistors 463, 464, 465, 466, 471, 472, 473, and 474 act as pull-ups to power or pull-downs to ground for various signals on the serial ROMs 461, 462, 469, and 470. Another group of resistors 467, 468, 475, and 476 are for debug purposes and provide easier debug access to the I²C bus signals used by the audio processor 202 to communicate with the serial ROMs 461, 462, 469, and 470. A pair of bypass capacitors 506 and 507 provide filtering for power to the serial ROMs 461, 462, 469, and 470.

The digital to analog converter 206, or DAC, may be, for example, a Texas Instruments TLC320AD77C. Power filtering, as well as filtering of the common voltage to the amplifiers 437 and 451 is handled by a plurality of capacitors 399, 400, 401, 402, 508, and 509. Filtering for the DAC reference voltage is provided by another group of capacitors 403, 404, 405, 406, and 407. A plurality of resistors 395, 396, 397, 398, 408, 409, and 410 provide pull-ups to power or pull-downs to ground for various signals on the DAC 206. The analog audio 109 from the DAC 206 goes through filtering circuitry that provides a frequency band pass from roughly 20 Hz to 20,000 Hz. This band pass filtering circuitry is formed from a plurality of operational amplifiers, or op amps, 429, 437, and 451, a plurality of resistors 425, 426, 431, 433, 438, 441, 443, 444, 446, 448, 450, 452, 455, 457, 458, and 512, and a plurality of capacitors 427, 428, 430, 432, 439, 440, 442, 445, 447, 449, 453, 454, 456, and 511. The filtered audio goes to the line level output connector 459. The inductor 434 and the capacitors 435 and 436 provide filtering on the power to the op amps 429, 437, and 451.

There are multiple voltage levels required by the different hardware sections in the base station 104. An external 9 to 12 volt power supply provides all power to the base station 104 and connects to the base station 104 through a power jack 485. A diode 486 provides a voltage drop and reverse polarity protection for the external power supply. A capacitor 487 provides filtering on the power from the external power supply. Since there are various voltage levels required in this specific implementation, there are multiple levels of voltage regulation. A voltage regulator 488 converts the voltage from the external power supply voltage to 5 volts. A light emitting diode, or LED, 490 provides visual feedback to the user that the base station 104 is successfully powered. Resistor 489 provides additional loading for the LED 490, to reduce the current going through the LED 490. A bypass capacitor 491 provides filtering on the 5-volt power from the voltage regulator 488. There are two additional voltage levels required in this particular embodiment of the base station 104. The first is 3.3 volts, which is used by components throughout the design. The other is a 1.5-volt core voltage for this specific audio processor 202. A dual output voltage regulator 494, for example, a Texas Instruments TPS70148, provides these two voltage levels. Capacitors 499, 500, 504, and 505 provide filtering on the power outputs from a dual output voltage regulator 494. A plurality of resistors 495, 496, and 497 are for debug purposes and allow removal of 3.3-volt power to different sections in the design. Another group of resistors 492, 493, and 498 act as pull-ups to power or pull-downs to ground for various signals on the dual output voltage regulator 494. A plurality of ferrite beads 501, 502, and 503 may be used to provide noise filtering and isolation between the various ground planes in the base station 104 design.

A unique identifier 513, which can be used for decrypting on a device specific basis, may be, for example, a Dallas Semiconductor DS2401. The unique identifier 513 includes a single pin serial interface that can be connected to the USB interface controller 201 through the resistor 411 or to the audio processor 202 through the resistor 412. The real-time clock 514 may be provided, for example, a Philips Semiconductor PCF8563. The real-time clock 514 communicates on the I²C bus with the USB interface controller 201, with the resistors 421 and 422 providing easier debug access to the I²C bus clock and data signals. Power to the real-time clock 514 is normally provided from the 5-volt regulator 488. When the external power supply is not available, the battery 416 provides power to the real-time clock 514 in order to maintain the correct time. A diode 418 prevents the 5-volt power from charging the battery 416 while a diode 419 prevents the current from the battery 416 from leaking into the 5-volt power circuit. A resistor 417 provides additional loading in case the diode 418 fails. A bypass capacitor 420 provides filtering on the power to the real-time clock 514. An oscillator 423 provides a timing count for the real-time clock 514, while the capacitor 424 provides a load as required by the oscillator 423.

A connector 349 is used for connection to an external JTAG emulator. The JTAG interface connects to the audio processor 202 and is used for debugging of code running on the audio processor 202. A plurality of resistors 348, 350, and 351 are used to pull-up to power or pull-down to ground certain signals on connector 349 that go to the audio processor 202 in case the JTAG emulator is not connected. The connector 349 is removed in production. A connector 390 is used for connection to an external 8051 emulator. The 8051 emulation interface connects to the USB interface controller 201 and is used for debugging of code running on the USB interface controller 201. The connector 390 is not used for production. A connector 415 provides easy debug access to the clock and data signals on the I²C bus, which is used by the USB interface controller 201 or audio processor 202 to access peripherals such as the real-time clock 514, USB firmware ROM 203, and DSP firmware ROM 204. A connector 415 may be removed in production. A pair of resistors 413 and 414 are used as pull-ups to power for the I²C bus clock and data signals. A plurality of inverters 344, 345, 346, and 347 are not used, but are within a part that is being used. Similarly, an Op amp 460 is not used, but is within a part that is being used. Lastly, a resistor 318 is not used and is not placed on the circuit board.

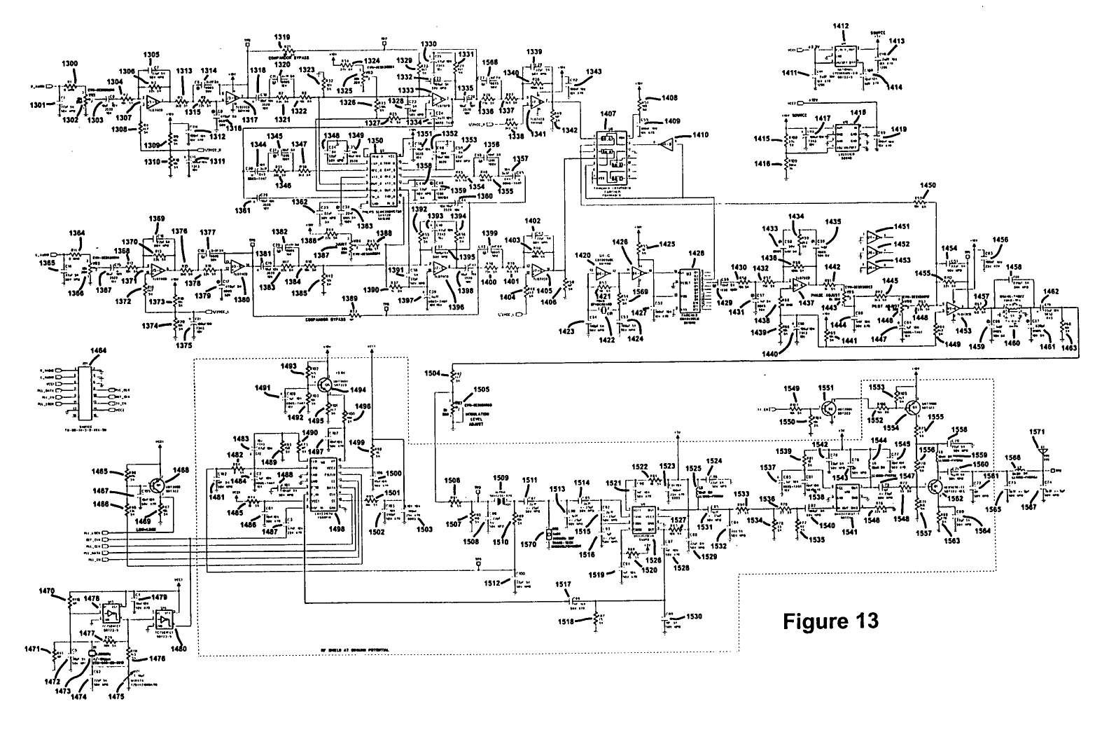

The connector 394 on the base station 104 provides connection to an optional external module, which is not described here. A pair of resistors 392 and 393 may be provided for debug purposes and provide easier debug access to the I²C bus signals used by the USB interface controller 201 to communicate with the optional external module. The connector 391 on the base station 104 provides connection to the audio or video transmitter 209, described later (FIG. 13).

Audio or Video Transmitter Schematic

FIG. 13 represents the schematic design for an exemplary embodiment of the audio or video transmitter 209. In this particular embodiment, the audio or video transmitter 209 is used to transmit an analog audio signal. The audio transmitter 209 connects to the audio or video transmission peripheral 104, also called the base station 104, using a connector 1464 on the audio transmitter 209. The base station 104 sets the transmission frequency of the audio transmitter 209 through a serial interface with a frequency synthesizer 1498, for example, a National Semiconductor LMX2316, on the audio transmitter 209. An oscillator 1473, along with a plurality of resistors 1470, 1471, 1476, and 1477, capacitors 1472, 1474, 1479, and 1487, a variable capacitor 1475, and buffers 1478 and 1480 provide the reference frequency to the frequency synthesizer 1498. Another group of resistors 1482, 1489, 1490, and 1501 and capacitors 1481, 1483, 1484, 1488, 1502, and 1503 provide additional support for the frequency synthesizer 1498. A plurality of resistors 1465, 1466, and 1469, a capacitor 1467, and a transistor 1468 act as a frequency synthesis PLL lock detect circuit to provide PLL lock detection feedback to the base station 104 when transmission frequency changes are made. A transistor 1494, a pair of capacitors 1491 and 1497, and a group of resistors 1492, 1493, 1495, and 1496 provide filtering for power to the charge pump inside the frequency synthesizer 1498. A pair of resistors 1485 and 1499 and a pair of capacitors 1486 and 1500 provide filtering for digital power to the frequency synthesizer 1498.

Line level stereo audio comes from the base station 104 to the audio transmitter 209 from the connector 1464 on the audio transmitter 209. The stereo audio signals first go through audio filtering and gain adjustment composed of a group of capacitors 1301, 1303, 1305, 1311, 1312, 1314, 1316, 1365, 1367, 1369, 1375, 1377, and 1379, resistors 1300, 1304, 1306, 1308, 1309, 1310, 1313, 1315, 1364, 1368, 1370, 1372, 1373, 1374, 1376, and 1378, variable resistors 1302 and 1366, and op amps 1307, 1317, 1371, and 1380. In order to improve the signal to noise ratio, the stereo audio signals next pass through a dynamic range compression circuit. A compandor 1350, for example, a Philips Semiconductors SA572, is configured to operate for compression. A group of resistors 1321, 1322, 1323, 1324, 1326, 1327, 1329, 1331, 1346, 1347, 1354, 1355, 1383, 1384, 1385, 1386, 1388, 1390, 1392, and 1394, variable resistors 1325 and 1387, capacitors 1318, 1320, 1328, 1330, 1332, 1334, 1335, 1344, 1345, 1348, 1349, 1352, 1353, 1356, 1357, 1358, 1359, 1360, 1361, 1362, 1363, 1381, 1382, 1391, 1393, 1395, 1397, and 1398, and op amps 1333 and 1396 support operation of the compandor 1350 for dynamic range compression of the stereo audio signals. A pair of resistors 1319 and 1389 provide an option to bypass the compression circuit. A capacitor 1351 provides filtering for power to the compandor 1350. Next the stereo audio signals passes through a pre-emphasis circuit to boost the high frequencies in the signals. A group of resistors 1336, 1337, 1338, 1340, 1342, 1400, 1401, 1403, 1404, and 1406, capacitors 1339, 1399, 1402, and 1568, and op amps 1341 and 1405 make up the pre-emphasis circuit. A capacitor 1343 provides filtering for power to the op amps 1333, 1343, 1396, and 1405. After the pre-emphasis circuit, the stereo audio signals go through a stereo encoding process that involves time division multiplexing of the stereo audio signals. A switch 1407, for example, a Fairchild Semiconductor CD4066, provides the multiplexing while the oscillator 1422 acts as the timing source for controlling the switch 1407. A counter 1428 divides down the timing from the oscillator 1422 to get the correct multiplexing timing. A group of capacitors 1423 and 1424, resistors 1421 and 1569, and inverters 1410, 1420, and 1426 support multiplexing timing generation by the oscillator 1422 and counter 1428. A resistor 1408 and a capacitor 1409 provide power filtering for the switch 1407. A resistor 1425 and a capacitor 1427 provide power filtering for the counter 1428 and the inverters 1410, 1420, 1426, 1451, 1452, and 1453. The inverters 1451, 1452, and 1453 are unused. The counter 1428 also provides the timing for a pilot tone that is used by the audio receiver 241 in the audio or video receiver device 105, also called the repeater 105 in this description, to detect a transmission from the audio transmitter 209. A group of resistors 1430, 1432, 1434, 1436, 1438, 1439, 1441, 1442, 1445, 1448, and 1449, variable resistors 1443 and 1446, capacitors 1429, 1431, 1433, 1435, 1440, 1444, and 1447, and op amp 1437 are responsible for converting the square wave timing from the counter 1428 to a sine wave as well as providing phase, level, and gain adjustments on the pilot tone. The pilot tone signal and multiplexed audio signal are combined into one signal for transmission, with a group of resistors 1450, 1455, 1457, and 1463, capacitors 1454, 1458, 1459, 1461, and 1462, variable inductor 1460, and op amp 1453 acting as the combiner circuit. A capacitor 1456 provides power filtering for the op amps 1437 and 1453. The combined signal modulates the VCO circuit through a resistor 1504 and a variable resistor 1505. The VCO circuit is composed of a group of resistors 1506, 1507, 1510, 1518, 1520, 1527, and 1533, capacitors 1508, 1511, 1512, 1513, 1514, 1515, 1516, 1517, 1519, 1524, 1528, 1529, 1530, 1531, and 1532, varactor 1509, inductor 1525, ceramic resonator 1570, and RF oscillator 1526. A resistor 1522 and a pair of capacitors 1521 and 1523 provide filtering for power to the RF oscillator 1526. The signal from the VCO circuit goes to the VCO buffer amplifier 1541, with a group of resistors 1534, 1535, 1536, 1539, and 1546, capacitors 1537, 1538, 1540, 1542, 1543, and 1545, and inductor 1544 providing required support for the VCO buffer amplifier 1541. The signal from the VCO buffer amplifier 1541 is then sent to a power amplifier circuit composed of a group of resistors 1548, 1556, 1557, and 1563, capacitors 1547, 1558, 1560, 1561, and 1564, inductor 1559, and transistor 1562. The base station 104 is able to enable or disable the power amplifier circuit from a control signal to the audio transmitter 209. The control signal comes to the audio transmitter through the connector 1464 on the audio transmitter 209. The control signal enables or disables the power amplifier circuit through the switch circuit composed of a group of resistors 1549, 1550, 1552, 1553 and 1555 and transistors 1551 and 1554. Finally the signal to transmit passes through the output filter composed of an inductor 1566 and a pair of capacitors 1565 and 1567 before going out the audio antenna 1571.

The audio transmitter 209 is supplied power at 3.3 volts and 12 volts from the base station 104 through the connector 1464 on the audio transmitter 209. A voltage regulator 1412 converts the 3.3-volt power to 3-volt power. A group of capacitors 1411, 1413, and 1414 support required filtering for the voltage regulator 1412. The voltage regulator 1418 converts the 12-volt power to 10-volt power. A pair of capacitors 1417 and 1419 support required filtering for the voltage regulator 1418. A pair of resistors 1415 and 1416 select the desired output voltage level for the voltage regulator 1418.

Audio or Video Receiver Device Schematic

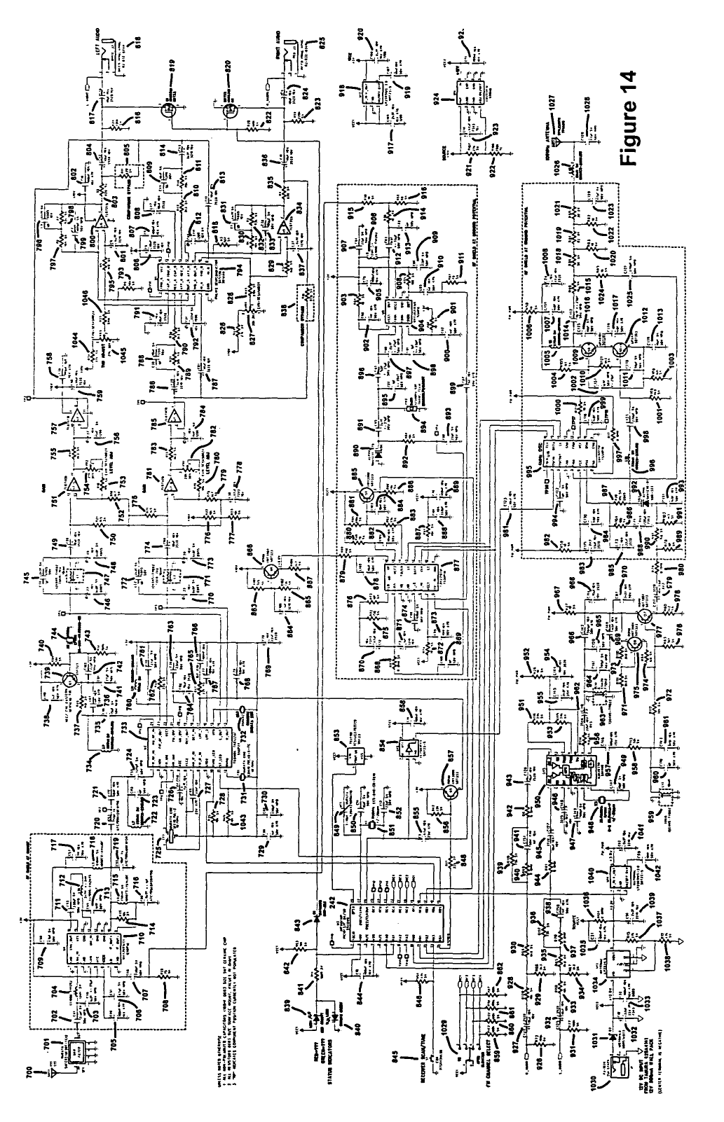

FIG. 14 represents the schematic design for an exemplary embodiment of the audio or video receiver device 105, also called the repeater 105 in this description. In this particular embodiment, the repeater 105 only receives an analog audio signal. As shown previously (FIG. 6), the repeater 105 is composed of four sections, the controller 242, the user controls 244, the audio receiver 241, and the FM transmitter 243. The controller 242, for example, a Microchip PIC16C57, interprets the selections for the user controls 244. The switch 1029 selects the FM transmission frequency, with resistors 859, 860, 861, and 862 acting as pull-downs to ground for the switch 1029 selections. Switch 845 signals that the audio receiver 241 should scan through the audio transmission frequencies for a wireless audio transmission signal from the audio or video transmission peripheral 104, also called the base station 104, to lock to. A resistor 846 acts as a pull-up to power for the switch 845. A pair of LEDs 839 and 840 are used to signal the user the status of receiving an audio transmission from the base station 104 by the audio receiver 241 on the repeater 105. A resistor 841 provides additional loading to limit the current to the LEDs 839 and 840, while a resistor 842 acts as a pull-up to power for the status signal that controls the LEDs 839 and 840. A voltage detector 853 generates the reset signal to the controller 242 to reset the controller 242. An oscillator 851 provides the timing for the controller 242. A pair of capacitors 850 and 852 and variable capacitor 849 provide the required loading for the oscillator 851. A capacitor 844 provides filtering for power to the controller 242.

Wireless audio transmissions from the base station 104 come to the repeater 105 through the audio antenna 700 on the repeater 105. The audio signal first passes through SAW filter 701, which acts as a band pass filter. The signal then feeds into the low noise amplifier, or LNA, and down converter mixer 710, for example, a Maxim Integrated Products MAX2685. The LNA and down converter mixer 710 down converts the audio signal for use by the FM stereo receiver and decoder 733. A pair of capacitors 702 and 703 and an inductor 704 provide impedance matching of the signal to the input of the LNA inside the LNA and the down converter mixer 710. A group of capacitors 711 and 713 and an inductor 712 provide impedance matching from the output of the LNA inside the LNA and down converter mixer 710 to the input of the mixer, also inside the LNA and down converter mixer 710. The down converted audio output signal from the LNA and down converter mixer 710 then passes through an impedance matching and filtering circuit composed of a group of capacitors 716, 717, 719, 720, 721, 723, and 724, resistor 714, and inductors 715, 718, and 722. Another group of capacitors 705, 706, 709 provide filtering for power to the LNA and down converter mixer 710. The local oscillator used by the LNA and down converter mixer 710 comes from the voltage controlled oscillator, or VCO. The VCO circuit is composed of a group of resistors 708, 892, 901, 908, 911, 914, 915, and 916, capacitors 707, 891, 893, 895, 896, 897, 898, 899, 900, 907, 909, 910, 912, and 913, varactor 890, inductor 906, ceramic resonator 894, and RF oscillator 904. A resistor 903 and a pair of capacitors 902 and 905 provide filtering for power to the RF oscillator 904. The frequency synthesizer 877, for example, a National Semiconductor LMX2316, controls the VCO circuit. The controller 242 selects the frequency of the frequency synthesizer 877 through a serial interface with the frequency synthesizer 877. The controller 242 also provides the reference frequency for the frequency synthesizer 877 from the oscillator 851. The reference frequency is filtered by capacitor 855 before going to the frequency synthesizer 877. A group of resistors 868, 875, 876, and 887 and capacitors 869, 870, 871, 874, 888, and 889 provide additional support for the frequency synthesizer 877. Another group of resistors 881, 883, and 886, a capacitor 884, and a transistor 885 act as a frequency synthesis PLL lock detect circuit to provide PLL lock detection feedback to the controller 242 when receive frequency changes are made. A transistor 866, a pair of capacitors 864 and 878, and a group of resistors 863, 865, 867, and 879 provide filtering for power to the charge pump inside the frequency synthesizer 877. A group of resistors 872 and 880 and a pair of capacitors 873 and 882 provide filtering for digital power to the frequency synthesizer 877. The down converted audio signal then goes to the FM tuner 733, for example, a Toshiba TA8122. The FM tuner 733 does the multiplexed decoding and a final level of down conversion of the audio signal to base band. The oscillator 744 along with a group of resistors 737, 740, and 743, capacitors 735, 736, 738, 741, and 742, a transistor 739, and an inductor 734 provide the reference timing for the down conversion handled in the FM tuner 733. An oscillator 731 provides the reference frequency for the FM stereo decoding handled in the FM tuner 733. An oscillator 732 provides the reference frequency to the FM tuner 733 for synchronization with the pilot tone in the audio signal. A group of resistors 728, 762, 765, and 1043, capacitors 726, 727, 729, 730, 761, 763, 764, 766, 767, 768, and 769, an inductor 760, and a ceramic filter 725 provide additional support for the FM tuner 733. A pair of resistors 848 and 856 and a transistor 857 allows the controller 242 to force the FM tuner 733 to output mono instead of stereo, however, the FM tuner 733 normally outputs stereo audio signals. The stereo audio signals output from the FM tuner 733 first pass through a pilot trap filter to remove the pilot tone from the stereo audio signals. The pilot trap filter is composed of a group of capacitors 745, 746, 748, 770, 772, and 773, and variable inductors 747 and 771. The stereo audio signals then pass through a gain control circuit, composed of a group of resistors 750, 752, 753, 775, 776, 777, 779, and 780, variable resistors 754 and 782, capacitors 749, 774, and 778, and op amps 751 and 781. The stereo audio signals then pass through a de-emphasis circuit to restore the high frequencies in the signals. A group of resistors 755 and 783, capacitors 756 and 784, and op amps 757 and 785 make up the de-emphasis circuit. A pair of capacitors 758 and 759 provide power filtering for the op amps 751, 757, 781, and 785. The stereo audio signals next pass through a dynamic range decompression circuit to match the compression done in the audio transmitter 209 in the base station 104. The compandor 794, for example, a Philips Semiconductor SA572, is configured to operate for decompression. A group of resistors 789, 790, 793, 795, 797, 798, 803, 810, 811, 815, 826, 828, 829, 830, 832, 835, 1044, and 1046, variable resistors 827 and 1045, capacitors 786, 787, 788, 791, 792, 796, 799, 801, 802, 804, 808, 809, 812, 813, 814, 831, 833, 836, and 837, and op amps 800 and 834 support operation of the compandor 794. A pair of resistors 805 and 838 provide an option to bypass the decompression circuit. A pair of capacitors 806 and 807 provide filtering for power to the compandor 794. A group of resistors 816 and 823 and capacitors 817 and 824 provide final filtering on the stereo audio signals before the stereo audio signals are output on the connectors 818 and 825. A resistor 822, diode 843, and a pair of transistors 819 and 820 act as a mute control circuit for use by the controller 242 to mute the stereo audio output signals.

The stereo audio output signals are also passed from the audio receiver 241 to the FM transmitter 243, also on the repeater 105, for broadcast. First, the stereo audio signals pass through a gain circuit, composed of a group of resistors 926, 928, 929, 930, 931, 933, 934, and 935 and capacitors 927 and 932. Next, the stereo audio signals pass through a pre-emphasis circuit to boost the high frequencies in the signals. Another group of resistors 936, 937, 939, 940, 942, and 944 and capacitors 938, 941, 943, and 945 make up the pre-emphasis circuit. After the pre-emphasis circuit, the audio signals go to the stereo modulator encoder 950, which handles the stereo encoding process that involves time division multiplexing of the stereo audio signals. A multiplexing circuit supports the stereo modulator encoder 950. The multiplexing circuit is composed of a group of resistors 951, 952, and 953 and capacitors 954 and 955. A pair of capacitors 946 and 947 provide additional support to the stereo modulator encoder 950. The multiplexed audio signal comes from the stereo modulator encoder 950 and passes through a low pass filter circuit. The low pass filter circuit is made up of a resistor 956, a group of capacitors 962, 964, 965, 966, and 969, and a variable inductor 963. The multiplexed audio signal then goes to a summing circuit where the multiplexed audio signal is summed with the pilot tone. Oscillator 948, supported by capacitor 949, provides the timing for the generation of the pilot tone, which is required for FM radio broadcast. The pilot tone comes from the stereo modulator encoder 950 and passes through a pilot filter, composed of a group of resistors 958 and 972, capacitors 957, 960, and 961, and variable inductor 959. The pilot tone is then goes to a summing circuit where the pilot tone is summed with the multiplexed audio signal. The summing circuit is composed of another group of resistors 971, 973, 974, 976, 978, and 980, a capacitor 979, and transistors 975 and 977. A resistor 967 and a pair of capacitors 968 and 970 provide power filtering for the summing circuit. The summed audio signal modulates the voltage controlled oscillator, or VCO, circuit to generate the FM radio signal. The VCO circuit is made up of a group of resistors 986, 987, 989, 990, 991, 1001, 1003, 1004, and 1010, capacitors 985, 988, 993, 998, 1002, 1011, 1013, 1014, 1016, and 1017, inductors 996 and 1005, varactor 992, and transistors 1009 and 1012. A resistor 1006 and a pair of capacitors 1007 and 1008 provide filtering for power to the VCO circuit. The VCO is controlled by the phase locked loop, or PLL, which is inside the frequency synthesizer 995. The frequency synthesizer 995 is, for example a National Semiconductor LMX1601. The controller 242 provides the reference frequency for the frequency synthesizer 995 through the inverter 854 and a filtering capacitor 981. A capacitor 858 provides power filtering for the inverter 854. A group of resistors 982 and 1000 and capacitors 983, 984, and 999 provide power filtering for the frequency synthesizer 995. A resistor 997 acts as a pull-up to power to the enable signal on the frequency synthesizer 995. A capacitor 994 provides filtering on an unused output from the frequency synthesizer 995. The frequency modulated signal goes from the VCO circuit to an output gain adjustment circuit, that affects the output power of the transmission. The output gain adjustment circuit is made up of a group of resistors 1015, 1018, 1019, 1020, 1021, 1022, and 1024 and a capacitor 1025. Finally the frequency modulated signal passes through a pi filter circuit, which is responsible for removing harmonics from the transmission signal, before going to the FM transmitter antenna 1027 for broadcast to a nearby FM radio 140. The pi filter circuit is made up of a pair of capacitors 1023 and 1028 and an inductor 1026.

Power to the repeater 105 comes from an external 12-volt unregulated power supply. The external power supply connects to the repeater 105 circuit board using a connector 1030 on the repeater 105. A diode 1031 provides protection for the repeater 105 in case an incorrect power supply is plugged into the repeater 105 on the connector 1030. The 12-volt unregulated power feeds into the voltage regulator 1034. A pair of capacitors 1032 and 1033 provide filtering for the 12-volt input to the regulator 1034. A group consisting of capacitors 1035 and 1039 and a resistor 1036 provide filtering for the 3.3-volt output from the regulator 1034. A pair of resistors 1037 and 1038 provide the output voltage selection for the regulator 1034. The 12-volt unregulated power also feeds into regulator 924 to provide 10-volt power to the audio receiver 241. A capacitor 925 provides filtering for the 12-volt input to the regulator 924, while a capacitor 923 provides filtering for 10-volt output from the regulator 924. A pair of resistors 921 and 922 provide the output voltage selection for the regulator 924. Additional 3-volt power is supplied by a regulator 918, with a capacitor 917 acting as filter for input power, a capacitor 920 acting as a filter for output power and a capacitor 919 providing bypass support for the regulator 918. A regulator 1040 supplies power to the FM transmitter 243. The controller 242 controls output from the regulator 1040, so the FM transmitter 243 can be selectively powered down. A capacitor 1041 provides filtering for the power output from the regulator 1040 and a capacitor 1042 provides the required bypass support for the regulator 1040.

Obviously, many modifications and variations of the present invention are possible in light of the above teachings. Thus, it is to be understood that, within the scope of the appended claims, the invention may be practiced otherwise than as specifically described above.

What is claimed and desired to be covered by a Letters Patent is as follows:

We claim:

1. A digital content playback system comprising:
a computing platform for receiving encrypted digital content by way of a first communication link;
a digital content transmission peripheral for receiving said encrypted digital content, said digital content transmission peripheral configured to decrypt said encrypted digital content defining decrypted digital content;
a digital content receiver for receiving decrypted digital content over a second communications link;
a digital content player coupled to said digital content receiver by way of a third communication link for playback of said digital content.

2. The digital content playback system as recited in claim 1, wherein said digital content is audio content.

3. The digital content playback system as recited in claim 1, wherein said digital content is video content.

4. The digital content playback system as recited in claim 1, wherein said digital content transmission peripheral is configured to convert said decrypted digital content to analog data.

5. The digital content playback system as recited in claim 1, wherein said first communication link is a computer network.

6. The digital content playback system as recited in claim 5, wherein said computer network is the Internet.

7. The digital content playback system as recited in claim 1, wherein said second communication is a wireless communication link.

8. The digital content playback system as recited in claim 7, wherein said wireless communication link is an RF link.

9. The digital content playback system as recited in claim 1, wherein said third communication link is a wireless link.

10. The digital content playback system as recited in claim 9, wherein said wireless communication link is an RF link.

11. A method for transmitting secure digital content comprising the steps of:
(a) receiving encrypted digital content by way of a computing platform;
(b) transmitting said encrypted digital content to a peripheral device;
(c) decrypting said encrypted digital content in said peripheral device; and
(d) transmitting said decrypted digital content to a receiver coupled to a digital playback device.

12. The method as recited in claim 11, further including the step of (e) converting said decrypted digital content to analog data before transmission to a receiver coupled to a digital playback device.
